(19) United States
(12) Patent Application Publication
(10) Pub. No.: US 2015/0276171 A1
(43) Pub. Date: Oct. 1, 2015

(54) LAMP FOR VEHICLE

(71) Applicant: Hyundai Mobis Co., Ltd., Seoul (KR)

(72) Inventor: Dong Gon KANG, Yongin-si (KR)

(21) Appl. No.: 14/660,558

(22) Filed: Mar. 17, 2015

(30) Foreign Application Priority Data
Mar. 26, 2014 (KR) 10-2014-0034986

(51) Int. Cl. F21V 5/04; F21V 5/00; F21S 8/10

(52) U.S. Cl. CPC F21V 5/045; F21S 48/00; F21S 48/328; F21V 5/008; F21Y 2101/02

(57) ABSTRACT

A lamp for a vehicle, including: a light source disposed on a substrate; and a primary optic lens positioned on a line along which light radiates from the light source. The primary optic lens may be a Fresnel lens, thereby reducing an overall size of the lamp for a vehicle by reducing a thickness of the lens.

### CROSS-REFERENCE TO RELATED APPLICATIONS

This application claims priority from and the benefit of Korean Patent Application No. 10-2014-0034986, filed on Mar. 26, 2014, which is hereby incorporated by reference for all purposes as if fully set forth herein.

### BACKGROUND

1. Field

Exemplary embodiments relate to a lamp for a vehicle, and more particularly, exemplary embodiments relate to a lamp for a vehicle, which has a primary optic lens, thereby reducing an overall size of the lamp.

2. Discussion of the Background

In general, a vehicle has a lighting system in order to allow a driver to easily confirm objects positioned in a traveling direction when the vehicle travels at night, and to inform a driving state of a host vehicle to drivers of other vehicles or other users who use a road.

Regarding the lamp for a vehicle, a light source has been developed from a point-type light source into a line-type light source and, more recently, the light source has been developed into a surface-type light source for emitting surface-type light.

FIG. 1 illustrates a structure of an optical system in the related art which implements a surface-type light source.

Referring to FIG. 1, the structure of an optical system that implements a surface-type light source includes light-emitting diodes (LED)s 2 that are provided on a printed-circuit board (PCB) 1 circuit substrate, and a reflector 3 that is formed to have a curved surface in front of the light source and reflects light toward a front lens 4 of the lamp.

The light source has been developed to reflect the surface light source in response to design trends of the lamp for a vehicle. However, the surface light source having the aforementioned structure adopts a plurality of LEDs, and uses a light diffusion agent on a reflective surface in order to implement a uniform image of emitted light. As a result, the efficiency in using light is extremely low. Korean Patent No. 10-1295827 presents a method of using an aspherical lens which is positioned in front of the LED light source and diffuses light.

However, in the case of the structure using the aspherical lens, there are problems in that the total thickness of the lamp structure for a vehicle may become undesirably increase due to a thickness of the thick lens, and the aspherical lens is not applied for a specific design.

The above information disclosed in this Background section is only for enhancement of understanding of the background of the inventive concept, and, therefore, it may contain information that does not form the prior art that is already known in this country to a person of ordinary skill in the art.

### SUMMARY

Exemplary embodiments of the present invention reduce an overall size of a lamp for a vehicle by reducing a thickness of a lens utilized therein.

Exemplary embodiments of the present invention implement a surface light source using a small number of LEDs by using a primary optic lens.

Exemplary embodiments of the present invention also reduce costs for LED products by reducing the number of LEDs, and improve fuel efficiency of the vehicle by reducing power consumption of the LEDs.

Additional aspects will be set forth in the detailed description which follows, and, in part, will be apparent from the disclosure, or may be learned by practice of the inventive concept.

An exemplary embodiment of the present invention discloses a lamp for a vehicle, including: a light source disposed on a substrate; and a primary optic lens positioned on a line along which light radiates from the light source, wherein the primary optic lens comprises a Fresnel lens.

The foregoing general description and the following detailed description are exemplary and explanatory and are intended to provide further explanation of the claimed subject matter.

### BRIEF DESCRIPTION OF THE DRAWINGS

The accompanying drawings, which are included to provide a further understanding of the inventive concept, and are incorporated in and constitute a part of this specification, illustrate exemplary embodiments of the inventive concept, and, together with the description, serve to explain principles of the inventive concept.

FIG. 1 illustrates a structure of an optical system in the related art which implements a surface-type light source.

FIG. 2 is a cross-sectional view of a lamp for a vehicle according to an exemplary embodiment of the present invention.

FIG. 3 is a perspective view of a primary optic lens which is a constituent element of the lamp for a vehicle according to the exemplary embodiment of the present invention.

FIG. 4 is a cross-sectional view of the primary optic lens which is a constituent element of the lamp for a vehicle according to the exemplary embodiment of the present invention.

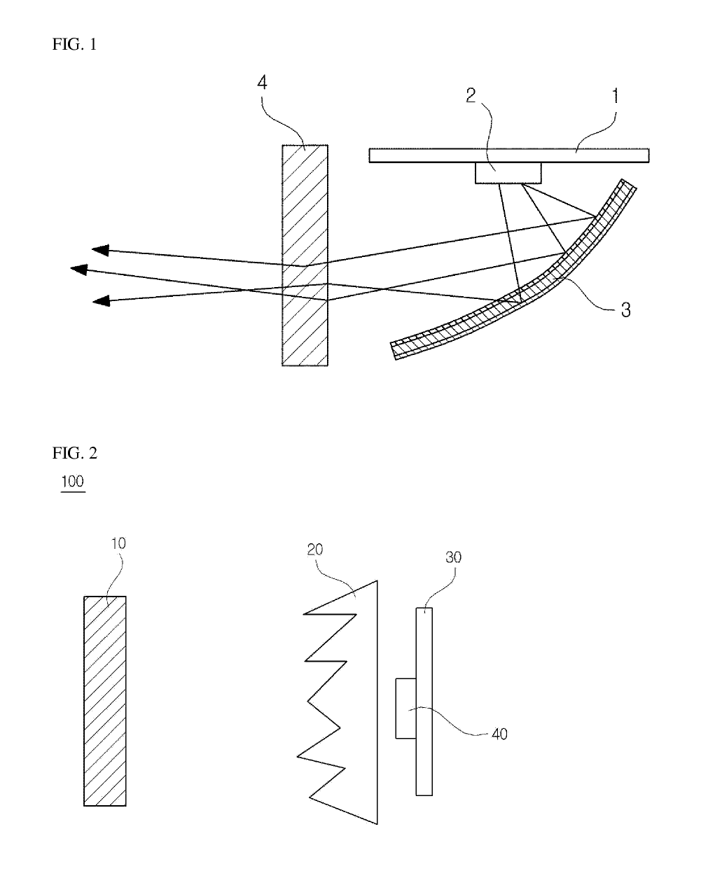

### DETAILED DESCRIPTION OF THE ILLUSTRATED EMBODIMENTS

In the following description, for the purposes of explanation, numerous specific details are set forth in order to provide a thorough understanding of various exemplary embodiments. It is apparent, however, that various exemplary embodiments may be practiced without these specific details or with one or more equivalent arrangements. In other instances, well-known structures and devices are shown in block diagram form in order to avoid unnecessarily obscuring various exemplary embodiments.

In the accompanying figures, the size and relative sizes of layers, films, panels, regions, etc., may be exaggerated for clarity and descriptive purposes. Also, like reference numerals denote like elements.

When an element or layer is referred to as being “on,” “connected to,” or “coupled to” another element or layer, it may be directly on, connected to, or coupled to the other element or layer or intervening elements or layers may be present. When, however, an element or layer is referred to as being “directly on,” “directly connected to,” or “directly coupled to” another element or layer, there are no intervening elements or layers present. For the purposes of this disclosure, “at least one of X, Y, and Z” and “at least one selected from the group consisting of X, Y, and Z” may be construed as X only, Y only, Z only, or any combination of two or more of X, Y, and Z, such as, for instance, XYZ, XYY, YZ, and ZZ. Like numbers refer to like elements throughout. As used herein, the term “and/or” includes any and all combinations of one or more of the associated listed items.

Although the terms first, second, etc. may be used herein to describe various elements, components, regions, layers, and/or sections, these elements, components, regions, layers, and/or sections should not be limited by these terms. These terms are used to distinguish one element, component, region, layer, and/or section from another element, component, region, layer, and/or section. Thus, a first element, component, region, layer, and/or section discussed below could be termed a second element, component, region, layer, and/or section without departing from the teachings of the present disclosure.

Spatially relative terms, such as “beneath,” “below,” “lower,” “above,” “upper,” and the like, may be used herein for descriptive purposes, and, thereby, to describe one element or feature's relationship to another element(s) or feature(s) as illustrated in the drawings. Spatially relative terms are intended to encompass different orientations of an apparatus in use, operation, and/or manufacture in addition to the orientation depicted in the drawings. For example, if the apparatus in the drawings is turned over, elements described as “below” or “beneath” other elements or features would then be oriented “above” the other elements or features. Thus, the exemplary term “below” can encompass both an orientation of above and below. Furthermore, the apparatus may be otherwise oriented (e.g., rotated 90 degrees or at other orientations), and, as such, the spatially relative descriptors used herein interpreted accordingly.

The terminology used herein is for the purpose of describing particular embodiments and is not intended to be limiting. As used herein, the singular forms, “a,” “an,” and “the” are intended to include the plural forms as well, unless the context clearly indicates otherwise. Moreover, the terms “comprises,” comprising,” “includes,” and/or “including,” when used in this specification, specify the presence of stated features, integers, steps, operations, elements, components, and/or groups thereof, but do not preclude the presence or addition of one or more other features, integers, steps, operations, elements, components, and/or groups thereof.

Various exemplary embodiments are described herein with reference to sectional illustrations that are schematic illustrations of idealized exemplary embodiments and/or intermediate structures. As such, variations from the shapes of the illustrations as a result, for example, of manufacturing techniques and/or tolerances, are to be expected. Thus, exemplary embodiments disclosed herein should not be construed as limited to the particular illustrated shapes of regions, but are to include deviations in shapes that result from, for instance, manufacturing. For example, an implanted region illustrated as a rectangle will, typically, have rounded or curved features and/or a gradient of implant concentration at its edges rather than a binary change from implanted to non-implanted region. Likewise, a buried region formed by implantation may result in some implantation in the region between the buried region and the surface through which the implantation takes place. Thus, the regions illustrated in the drawings are schematic in nature and their shapes are not intended to illustrate the actual shape of a region of a device and are not intended to be limiting.

Unless otherwise defined, all terms (including technical and scientific terms) used herein have the same meaning as commonly understood by one of ordinary skill in the art to which this disclosure is a part. Terms, such as those defined in commonly used dictionaries, should be interpreted as having a meaning that is consistent with their meaning in the context of the relevant art and will not be interpreted in an idealized or overly formal sense, unless expressly so defined herein.

Referring to FIG. 2, a lamp 100 for a vehicle according to an exemplary embodiment of the present invention includes a light source 40, a substrate 30, a primary optic lens 20, and a light diffusion lens 10.

The light source 40 emits light toward the front side or the rear side of the vehicle, and may be modified with various well-known constituent elements. In one exemplary embodiment, LEDs may be used as the light source 40.

The substrate 30 is positioned at the rear side of the lamp, and the light source 40 is provided on the substrate 30. The substrate 30 may be made of a material which may reflect light so that light is reflected toward the rear side from the light source 40 to the front side.

When LEDs are used for the light source 40, a large amount of heat may be generated during a process in which electrical energy is converted into light. Because such heat degrades luminous characteristics of the LED and shortens a lifespan of the LED, the substrate 30 may also serve as a heat radiating plate, or, alternatively, a heat radiating plate (not illustrated) may be provided on a rear surface of the substrate 30.

The primary optic lens 20 is positioned on a line along which light radiates from the light source 40, and diffuses light emitted from the light source 40 toward the front side of the lamp in order to implement the lamp having a surface light source.

The light diffusion lens 10 allows light passing through the primary optic lens 20 to exit to the outside of the lamp. The light diffusion lens 10 may have various shapes, such as an aspherical lens and a flat lens.

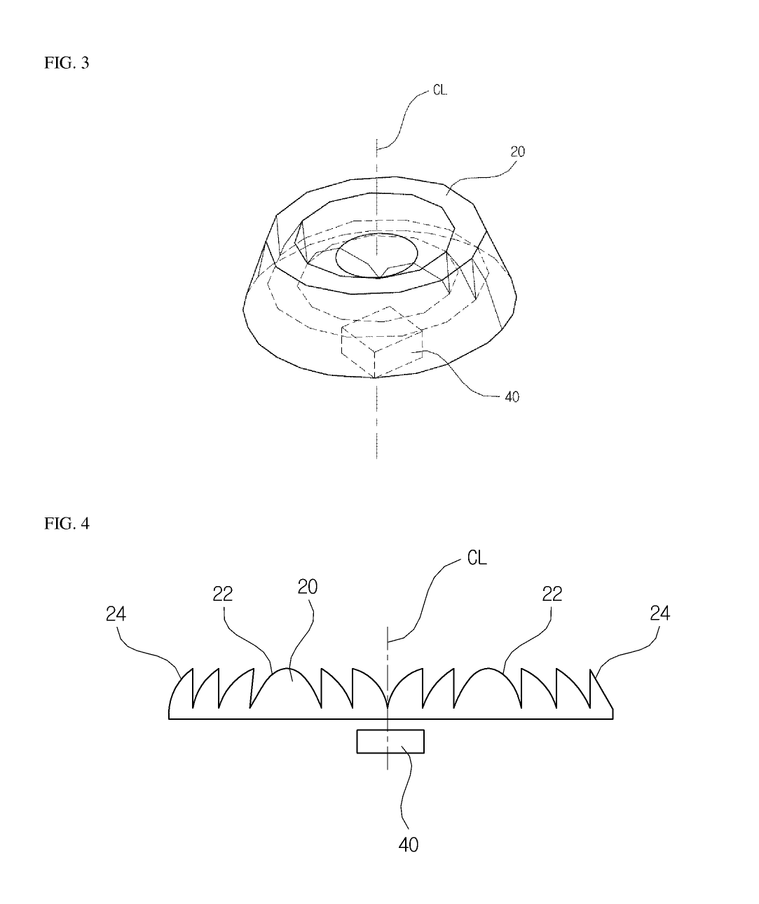

Referring to FIGS. 3 and 4, in an exemplary embodiment, a Fresnel lens may be used as the primary optic lens 20.

A Fresnel lens has lens surfaces having fine widths that are repetitively formed in a radial direction, and an optical axis of the overall lens is set as a central axis. The Fresnel lens may be made of various materials, and may be manufactured by a publicly known technology of compressing a material such as glass or plastic.

In an exemplary embodiment, the Fresnel lens may have a shape in which a cross-section that passes through a central axis CL is symmetrical about the central axis, and an outer circumferential surface of a cross-section perpendicular to the central axis CL has a circular shape or a polygonal shape.

The Fresnel lens includes a central portion 22, and a serrated portion 24. The central portion 22 is formed in a curved shape, and one or more serrated portions 24 are provided at the left and right sides of the central portion 22.

Curvature of the central portion 22, and inclination or curvature of the serrated portion 24, may be variously modified in order to adjust a refraction angle of light. In addition, a cross-section passing through the central axis CL may show one or more central portions 22 and a plurality of the serrated portion 24.

As described above, according to the lamp for a vehicle of the present invention, an overall size of the lamp for a vehicle may be reduced by reducing a thickness of the lens.

The LEDs, which are densely arranged to implement a uniform surface light source, may be arranged at longer intervals by greatly reducing an amount of light that is emitted from the LEDs in a normal line direction by using the primary optic lens, thereby reducing the required number of LEDs.

By reducing the number of LEDs, it is possible to reduce costs for LED products and improve fuel efficiency by virtue of reducing power consumption of the LEDs.

Although certain exemplary embodiments and implementations have been described herein, other embodiments and modifications will be apparent from this description. Accordingly, the inventive concept is not limited to such embodiments, but rather to the broader scope of the presented claims and various obvious modifications and equivalent arrangements.

What is claimed is:

1. A lamp for a vehicle, comprising:
a light source disposed on a substrate; and
a primary optic lens positioned on a line along which light radiates from the light source,
wherein the primary optic lens comprises a Fresnel lens.

2. The lamp of claim 1, wherein a cross-section of the Fresnel lens that passes through a central axis of the lens is symmetrical about the central axis.

3. The lamp of claim 1, wherein an outer circumferential surface of a cross-section of the Fresnel lens that is perpendicular to a central axis of the lens has a circular shape or a polygonal shape.

4. The lamp of claim 1, wherein:
the Fresnel lens comprises a central portion and a serrated portion; and
the central portion has a curved shape, and one or more serrated portions are provided at the left and right sides of the central portion.

5. The lamp of claim 1, wherein the light source comprises a light-emitting diode.

6. The lamp of claim 5, wherein the substrate serves as a heat radiating plate.

7. The lamp of claim 1, further comprising:
a light diffusion lens positioned in front of the primary optic lens.
